(19) United States
(12) Patent Application Publication
(10) Pub. No.: US 2013/0030753 A1
(43) Pub. Date: Jan. 31, 2013

(54) TESTING SYSTEM AND METHOD USING SAME

(71) Applicants: SHIH-FANG WONG, Tu-Cheng (TW); XIN LU, Shenzhen City (CN); YAO-HUA LIU, Shenzhen City (CN); ZHONG-LIN XU, Shenzhen City (CN)

(72) Inventors: SHIH-FANG WONG, Tu-Cheng (TW); XIN LU, Shenzhen City (CN); YAO-HUA LIU, Shenzhen City (CN); ZHONG-LIN XU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/330,686

(22) Filed: Dec. 20, 2011

(30) Foreign Application Priority Data
Jul. 29, 2011 (CN) 201110215413.8

(51) Int. Cl. G06F 19/00

(52) U.S. Cl. 702/119

(57) ABSTRACT

A remote server in electronic communication with a data center for testing one or more different types of electronic devices and method automatically tests one or more electronic devices. The data center stores a plurality of test programs correspondingly designed to test different types of electronic device. The remote server download one or more specified test programs corresponding to the electronic devices from the data center according to an identification code of each electronic device. The remote server tests the electronic devices by running the corresponding test programs.

### 1. TECHNICAL FIELD

The disclosure generally relates to test technologies, and particularly, to a testing system and method.

### 2. DESCRIPTION OF RELATED ART

Generally speaking, an electronic device is always tested by a test program before leaving factory. The test program is typically manually selected and downloaded from a server by an operator. However, different types of electronic devices must be tested by different specified test programs. If a larger number of different types of electronic devices need to be tested, the operator needs to manually change the specified programs, which is not convenient and results in low efficiency.

Therefore, it is desirable to provide a testing system and method which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a system view of one embodiment of a testing system.

FIG. 2 is a block diagram of one embodiment of the testing system of FIG. 1.

FIG. 3 is a flowchart of one embodiment of a testing method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

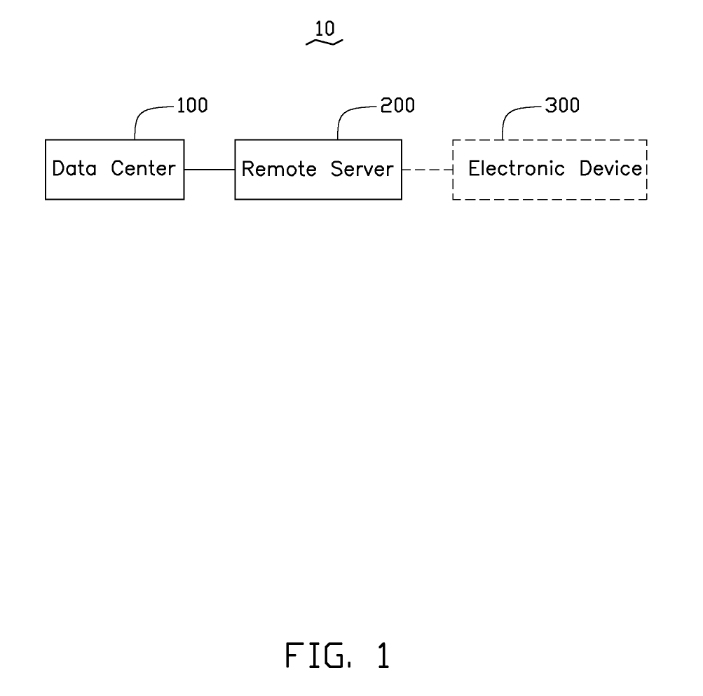

FIG. 1 is a system view of one embodiment of a testing system 10. In one embodiment, the testing system 10 may include a data center 100 and a remote server 200. The data center 100 is designed for cloud computering capacity. The remote server 200 is connected to the data center 100 via a network. The network may be, but is not limited to, a wide area network (e.g., the Internet) or a local area network. The remote server 200 may be a personal computer (PC), a network server, a thin client, or any other item of data-processing equipment. The remote server 200 connects with at least one electronic device 300 and tests the at least one electronic device 300. The electronic devices 300 may be, but are not limited to, a mobile phone, a personal digital assistant (PDA), or a tablet computer.

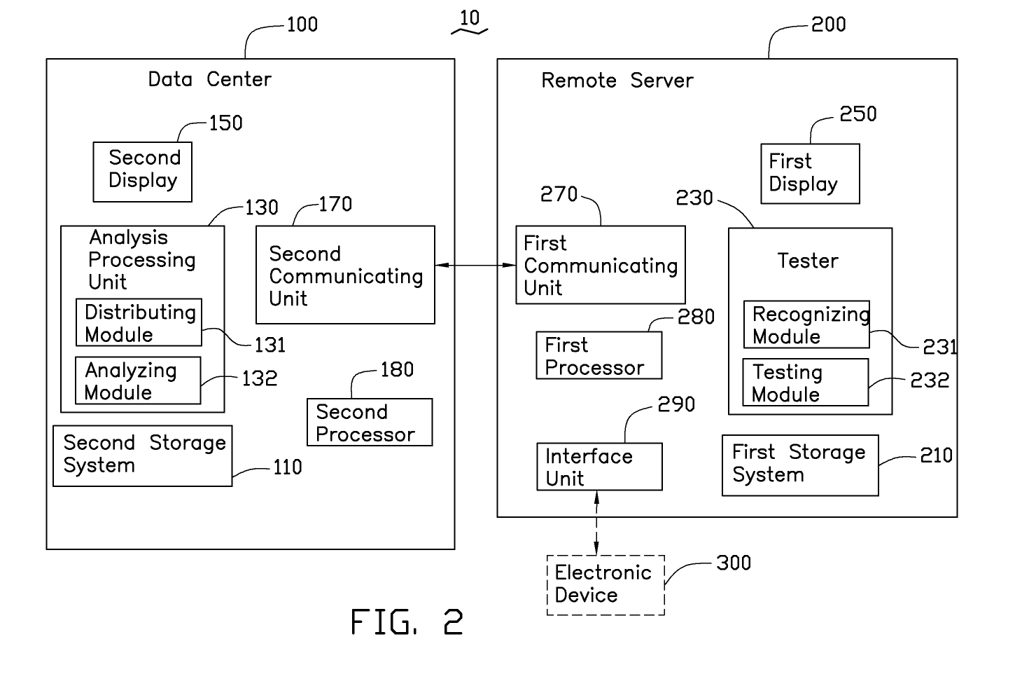

FIG. 2 is a block diagram of one embodiment of the data center 100 and the remote server 200. In one embodiment, the remote server 200 includes a first display 250, a first communicating unit 270, a tester 230, a first storage system 210, an interface unit 290, and at least one first processor 280. The data center 100 includes a second display 150, an analysis processing unit 130, a second communicating unit 170, a second storage system 110, and at least one second processor 180. In one embodiment, the tester 230 includes a recognizing module 231 and a testing module 232. The analysis processing unit 130 includes a distributing module 131 and an analyzing module 132. The modules 231-232 and 131-132 may include computerized code in the form of one or more programs that are correspondly stored in the first storage system 210 and the second storage system 110. The computerized code includes computer-readable program code (instructions) that are executed by the at least one first processor and at least one second processor 180 to provide functions for the modules 231-232 and 131-132. The first storage system 210 or the second storage system 110 may be a cache or a memory, such as an EPROM, HDD, or flash memory.

The second storage system 110 also stores a number of test programs designed to test the different types of electronic device 300. The first storage system 210 also stores an array including a collection of download request instructions corresponding to the test programs associated with a collection of identification codes corresponding to different types of electronic devices 300. Each identification code represents one type of electronic device 300. Each test program is designed to test one type of electronic device 300 represented by the corresponding identification code. The identification code may be a model code or a product code of the electronic device 300. Each test program may includes a number of sub-programs designed to test different functions of the electronic device 300. For example, the test program for testing a mobile phone may includes a media play test sub-program, a communication test sub-program, and a network connection test sub-program.

The first display 250 and the second display 150, such as a liquid crystal display (LCD) or an organic light emitting display (OLED), are configured for displaying a graphical user interface of the data center 100 and the remote server 200. The user can see the testing process and read the result of the test, such as a chart, a text, and figures, via the graphical user interface on the first display 250 and the second display 150. In one embodiment, the first display 250 and the second display 150 are touch panels. The user can manipulate the test via the first display 250 and the second display 150.

The first communicating unit 270 and the second communicating unit 170 are configured for exchanging data between the data center 100 and the remove server 200. The first communicating unit 270 or the second communicating unit 170 may be an antenna or a network port.

The interface unit 290 electronically connects with the electronic devices 300 for exchanging data between each electronic device 300 and the tester 230. In one embodiment, the interface unit 290 can be an universal serial bus (USB) or other hardware port. Connection between the electronic devices and the interface unit 290 may be through physically linked cables.

The recognizing module 231 receives the identification code of the electronic device 300 from the interface unit 290 when the electronic device 300 is connected to the interface unit 290. The recognizing module 231 determines one download request instruction corresponding to the specified test program designed to test the connected electronic device 300 in the array associated with the identification code of the connected electronic device 300 and sends the download request instruction of the specified test program to the distributing module 131 for downloading the specified test program designed to test the connected electronic device 300.

The distributing module 131 selects the specified test program from the test programs stored in the second storage system 110 according to the download request. The distributing module 131 transmits the specified test program to the testing module 232 via the communication between the first communicating unit 270 and the second communicating unit 170.

The testing module 232 receives the specified test program from the distributing module 131 and runs the specified test program to test the connected electronic device 300. One or more sub-programs of the specified test program can be selected to test the corresponding function of the connected electronic device 300. The testing module 232 transmits the test result of the connected electronic device 300 to the analyzing module 132 via the communication between the first communicating unit 270 and the second communicating unit 170.

The analyzing module 132 receives the test results of the different connected electronic devices 300 from the testing module 232. The analyzing module 132 analyzes the test results of the different connected electronic devices 300 to generate an analysis result. The analysis result may includes a comparative analysis about the test results and a statistical analysis about the test results. The analyzing module 132 transmits the analysis result to the first display 250 and the second display 150. The analysis result can be shown on the first display 250 and the second display 150 via the forms of chart, text, or figures.

In an alternative embodiment, the electronic device 300 may includes the tester 230 and the first communicating unit 270 mentioned above. Therefore, the electronic device 300 can directly connect with the data center 100 via a network and download the corresponding test program to test itself.

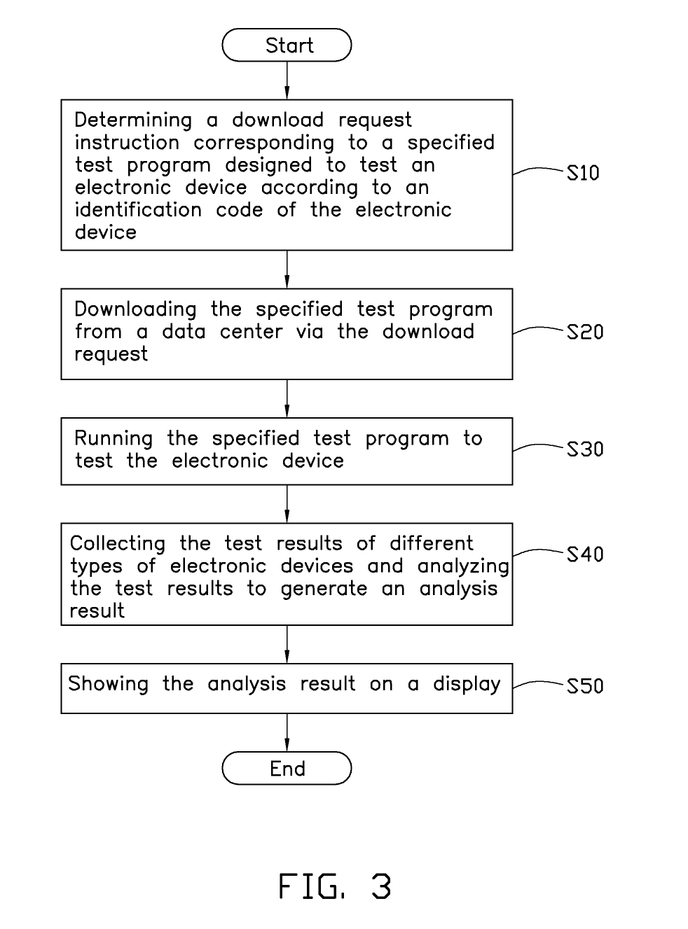

FIG. 3 is a flowchart of one embodiment of a testing method for automatically testing and analyzing different types of electronic devices 300. Depending on the embodiment, additional steps may be added, others deleted, and the ordering of the steps may be changed.

In step S10, the recognizing module 231 recognizes the type of the electronic device 300. In detail, the recognizing module receives the identification code of the electronic device 300 and determines a download request instruction corresponding to the specified test program designed to test the electronic device 300 in an array associated with the identification code of the electronic device 300.

In step S20, the recognizing module 231 downloads the specified test program from the data center 100. In detail, the recognizing module 231 sends the download request instruction of the specified test program to the distributing module 131. The distributing module 131 transmits the specified test program to the testing module 232 according to the download request instruction.

In step S30, the testing module 232 runs the specified test program to test the electronic device 300 and transmits the test result to the analyzing module 132.

In step S40, the analyzing module 132 collects the test results of different types of electronic devices 300 and analyzes the test results to generate an analysis result.

In step S50, the analyzing module 132 transmits the analysis result to the first display 250 and the second display 150. The analysis result is shown on the first display 150 and the second display 250 via the forms of chart, text, or figures.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A remote server in electronic communication with a data center, the data center storing a plurality of test program corresponding to different electronic devices, the remote server comprising:
an interface unit electronically connecting with at least one electronic device, and receiving an identification code transmitted from the at least one electronic device; and
a tester operable to download a specified test program designed to test the at least one electronic device from the data center according to the identification code, and run the specified test program.

2. The remote server of claim 1, wherein the tester comprises a recognizing module operable to determined a download request instruction of the specified test program according to the identification code and send the download request instruction to the data center.

3. The remote server of claim 2, wherein the recognizing module determines the download request instruction by looking up an array having a collection of download request instructions corresponding to a plurality of test program associated with a collection of identification codes corresponding to the different electronic devices, the remote server further comprises a storage system storing the array.

4. The remote server of claim 1, wherein the tester further comprises a testing module operable to test the at least one electronic device by running the specified test program.

5. The remote server of claim 4, wherein the data center further comprises a distributing module operable to transmit the specified test program to the testing module according to the download request instruction and an analyzing module operable to collect at least one test result about the at least one electronic device, analyze the test result, and generate an analysis result about the at least one electronic device, the analysis result comprising a comparative analysis about the test results and a statistical analysis about the test results.

6. The remote server of claim 5, wherein the remote server further comprises a first display, the data center further comprises a second display, the first display and the second display are configured for displaying the test results, the analysis result, and a testing process of the remote server or the data center.

7. The remote server of claim 6, wherein the first display and the second display are touch panels, the testing process is manipulated via the first display or the second display.

8. The remote server of claim 1, wherein further comprises a first communicating unit, the data center further comprises a second communicating unit, the remote server connects with the data center via a network between the first communicating unit and the second communicating unit.

9. The remote server of claim 1, wherein each test program comprises a plurality of sub-programs designed to test different functions of the at least one electronic device.

10. The remote server of claim 1, wherein the at least one electronic device is selected from the group consisting of a mobile phone, a personal digital assistant, and a tablet personal computer.

11. A testing method being performed by execution of computer readable program code by a processor of a remote server, the method comprising:
determining a download request instruction corresponding to a specified test program designed to test at least one electronic device according to an identification code of the at least one electronic device;
sending the download request instruction to a data center and downloading the specified test program stored in a storage system of the data center;
running the specified test program.

12. The method as claimed in claim 11, determining the download request instruction from an array which comprises a collection of download request instructions corresponding to the test programs associated with a collection of identification codes corresponding to different types of electronic devices.

13. The method as claimed in claim 12, further comprising sending at least one test result about the at least one electronic device to the data center, and generating an analysis result of the at least one electronic device.

14. The method as claimed in claim 13, further comprising displaying the at least one test result and the analyzing result on a first display of the remote server or a second display of the data center.

15. The method as claimed in claim 12, wherein the at least one electronic device is connected to the data center via a network, the array is storaged in the other storage system of the at least one electronic device.

16. An electronic device in electronic communication with a computer, the computer storing a plurality of test programs corresponding to different electronic devices, the electronic device comprising:
a storage system;
at least one processor; and
one or more programs stored in the storage system and being executable by the at least one processor, the one or more programs comprising:
a recognizing module operable to determine a download request instruction of the specified test program designed to test the electronic device and send the download request instruction to the computer for downloading the specified test program; and
a testing module operable to run the specified test program.

17. The electronic device as claim in claim 16, wherein the recognizing module determines the download request instruction by looking up an array having a collection of download request instructions corresponding to a plurality of test program associated with a collection of identification codes corresponding to different electronic devices, the array is stored in the storage system in the electronic device.

18. The electronic device as claimed in claim 16, wherein the computer further comprises a distributing module operable to transmit the specified test program to the testing module according to the download request instruction and an analyzing module operable to collect at least one test result about the at least one electronic device, analyze the test result, and generate an analysis result about the at least one electronic device, the analysis result comprises a comparative analysis about the test results and a statistical analysis about the test results.

19. The electronic device of claim 18, wherein the electronic device further comprises a first display, the computer further comprises a second display, the first display and the second display are configured for displaying the test results, the analysis result, and a testing process of the electronic device or the computer.

20. The electronic device of claim 19, wherein the first display and the second display are touch panel, the testing process is manipulated via the first display or the second display.
